(19) United States
(12) Patent Application Publication
(10) Pub. No.: US 2007/0029818 A1
(43) Pub. Date: Feb. 8, 2007

(54) Folding push bar mechanism for casement windows

(76) Inventors: Francis Manzella, Rockville Centre, NY (US); John G. Kirchner, Smithtown, NY (US)

Correspondence Address: BODNER & O'ROURKE, LLP, 425 BROADHOLLOW ROAD, SUITE 108, MELVILLE, NY, 11747, US

(21) Appl. No.: 11/481,429

(22) Filed: Jul. 5, 2006

Related U.S. Application Data
(60) Provisional application No. 60/696,561, filed on Jul. 5, 2005.

(51) Int. Cl. E05C 17/04

(52) U.S. Cl. 292/262

(57) ABSTRACT

A folding push bar mechanism for use with a casement window includes a folding push bar having a first linkage and a second linkage operatively coupled to the first linkage to pivot with respect thereto, and a push bar immobilizer. The push bar immobilizer is mounted on the frame of the casement window and selectively engages the push bar to prevent movement of the sash of the casement window with respect to the window frame. The push bar immobilizer preferably includes a pair of spaced apart, parallel, upper and lower plates between which the push bar passes, and a thumb screw which is threadingly received by the upper parallel plate and which selectively engages the push bar to prevent movement of the window sash with respect to the window frame.

### CROSS-REFERENCE TO RELATED APPLICATIONS

This application is related to U.S. Provisional Application Ser. No. 60/696,561, filed on Jul. 5, 2005, and entitled “Folding Push Bar for Casement Windows”, the disclosure of which is incorporated herein by reference. This application claims the benefit of priority under 35 U.S.C. 119 and/or 35 U.S.C. 120 to the aforementioned related provisional application.

### BACKGROUND OF THE INVENTION

1. Field of the Invention

The present invention relates to windows, and in particular casement windows, and more specifically relates to casement windows which have push bars for pivoting the window sash outwardly with respect to the window frame.

2. Description of the Prior Art

Some conventional casement windows include push bars which allow the window sash to pivot and extend outwardly with respect to the window frame on which it is mounted. Conventionally, the push bar is a non-articulating linkage which is pivotally attached to the sash and extends through an opening formed through the thickness of the window frame. To open the window, the user grasps the free end of the push bar and exerts pressure on the bar to force it at least partially through the frame opening in order to pivot the sash with respect to the frame.

One of the problems with this conventional arrangement of a casement window having a non-articulating push bar is that the window sash may only be opened partially (less than or about equal to 45 degrees) with respect to the frame. Another problem is that the non-articulating push bar, when retracted, extends its full length into the interior space and may interfere with window treatments, furniture and the like positioned at or near the casement window.

### OBJECTS AND SUMMARY OF THE INVENTION

It is an object of the present invention to provide a push bar mechanism for a casement window which allows the sash of the casement window to pivot open with respect to the frame to a greater degree than conventional casement windows.

It is another object of the present invention to provide a folding push mechanism bar for casement windows which does not interfere with window treatments, furniture and the like positioned near the casement window.

It is a further object of the present invention to provide a folding push bar for a casement window and a mechanism cooperating with the push bar selectively to prevent movement of the sash of the window with respect to the frame.

It is yet a further object of the present invention to provide a casement window and a push bar mechanism therefor which overcome the inherent disadvantages of known casement windows and push bars used therewith.

In accordance with one form of the present invention, a folding push bar mechanism for use with a casement window that has a frame and a sash hingedly mounted on the frame and moveable with respect thereto includes a push bar having a first linkage and a second linkage operatively coupled to the first linkage and pivotal with respect thereto, and a push bar immobilizer. The push bar immobilizer is mounted on the window frame and selectively engages the push bar to prevent movement of the window sash with respect to the window frame.

Preferably, the casement window frame includes a slot formed through the thickness thereof through which passes the folding push bar. Also, preferably, the second linkage of the folding push bar includes a free end, and a projection is mounted on the free end of the second linkage to prevent the push bar from entirely passing through the slot formed in the frame when the sash is opened with respect to the frame.

The present invention also includes a casement window having a frame and a sash hingedly mounted on the frame and moveable with respect thereto, which incorporates the folding push bar mechanism of the present invention described above.

These and other objects, features and advantages of the present invention will be apparent from the following detailed description of illustrative embodiments thereof, which is to be read in connection with the accompanying drawings.

### BRIEF DESCRIPTION OF THE DRAWINGS

FIG. 1 is a perspective view of a portion of a casement window formed in accordance with the present invention, having an articulating or folding push bar, also formed in accordance with the present invention, shown in a closed position.

FIG. 2 is a perspective view of a portion of the casement window of the present invention shown in FIG. 1, in a partially opened position, (i.e., about 45 degrees).

FIG. 3 is a perspective view of a casement window formed in accordance with the present invention, such as shown in FIG. 1, in an approximately 90 degree open position.

FIG. 4 is a perspective view of the casement window of the present invention, showing the folding push bar of the present invention attached to the window frame.

FIG. 5 is a perspective view of the window and push bar of the present invention shown in FIG. 4, with the folding push bar in a partially extended position.

FIG. 6 is another perspective view of the window and push bar of the present invention, showing the push bar's attachment to the window sash.

FIG. 7 is a perspective view of the casement window and push bar of the present invention, shown with the folding push bar fully extended to open the sash to about 90 degrees, or slightly less than that, with respect to the window frame.

FIG. 8 is a perspective view of the window and folding push bar of the present invention, illustrating the storage position of the push bar against the window frame.

### DETAILED DESCRIPTION OF THE PREFERRED EMBODIMENTS

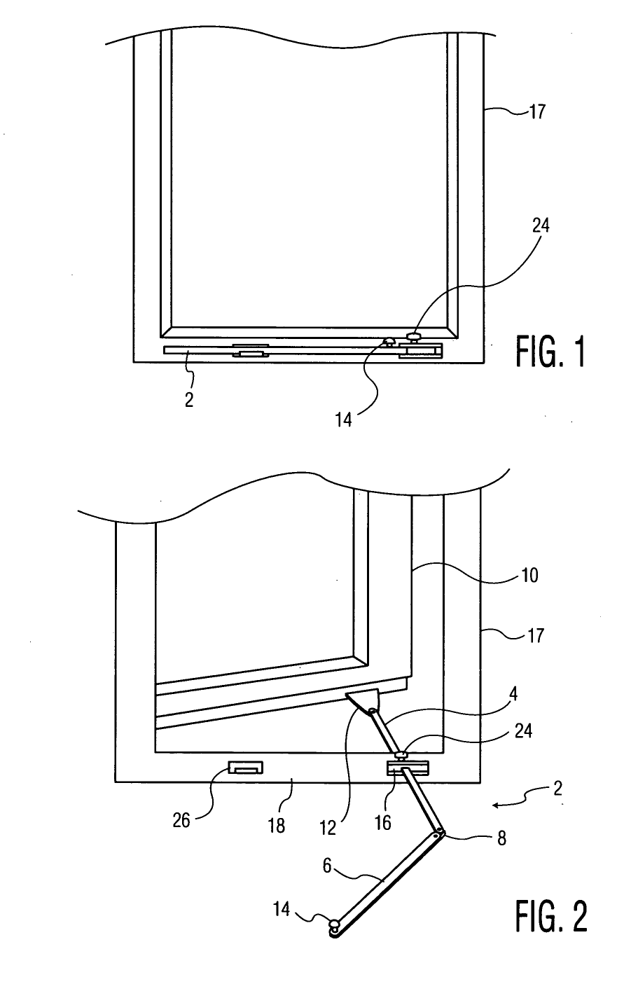

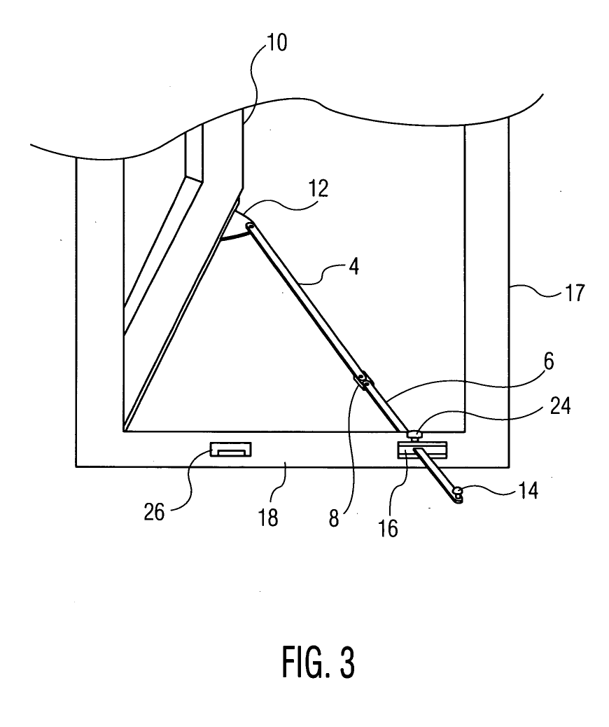

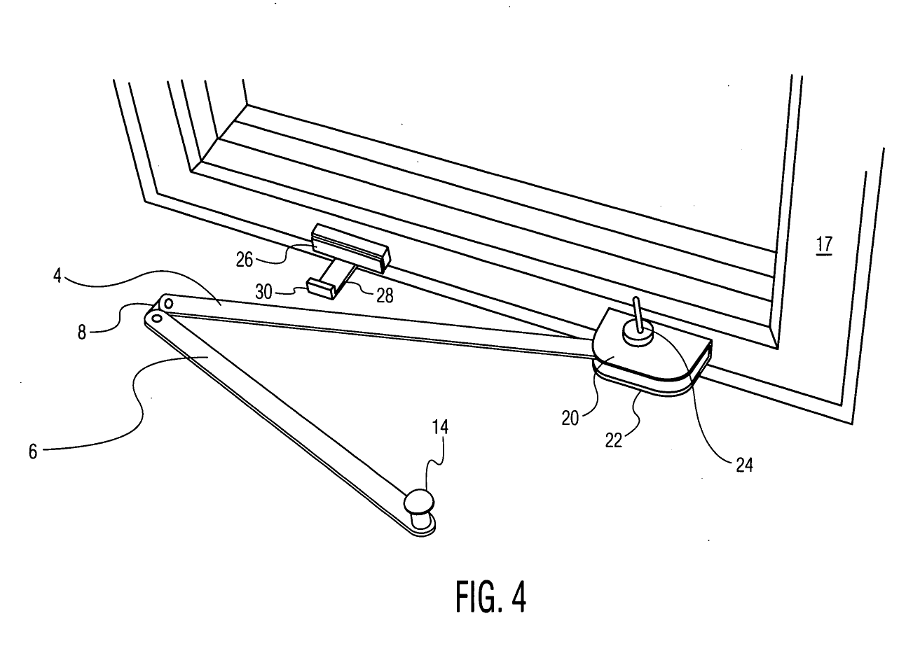

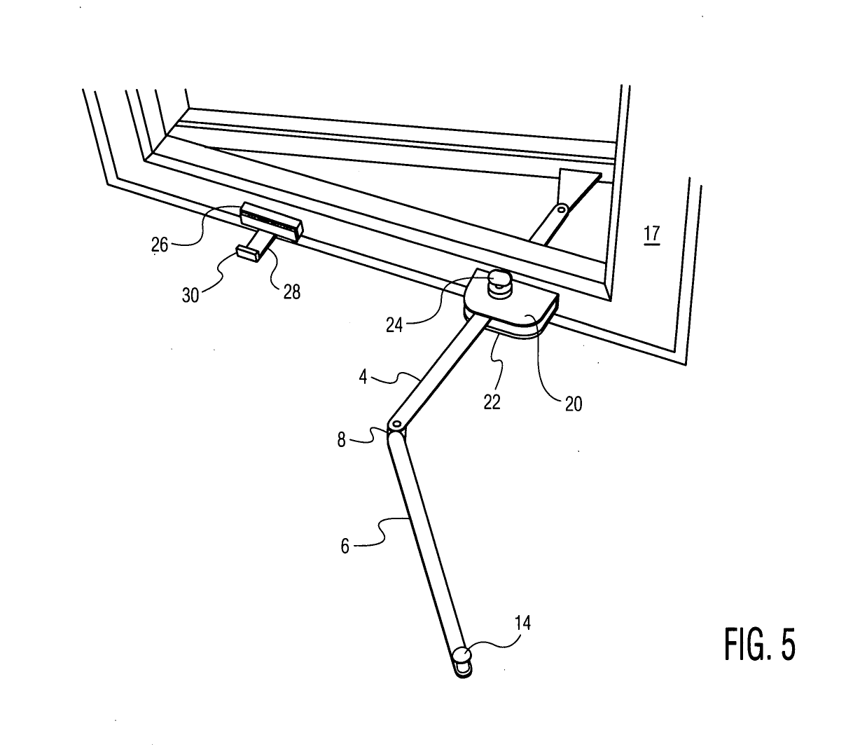

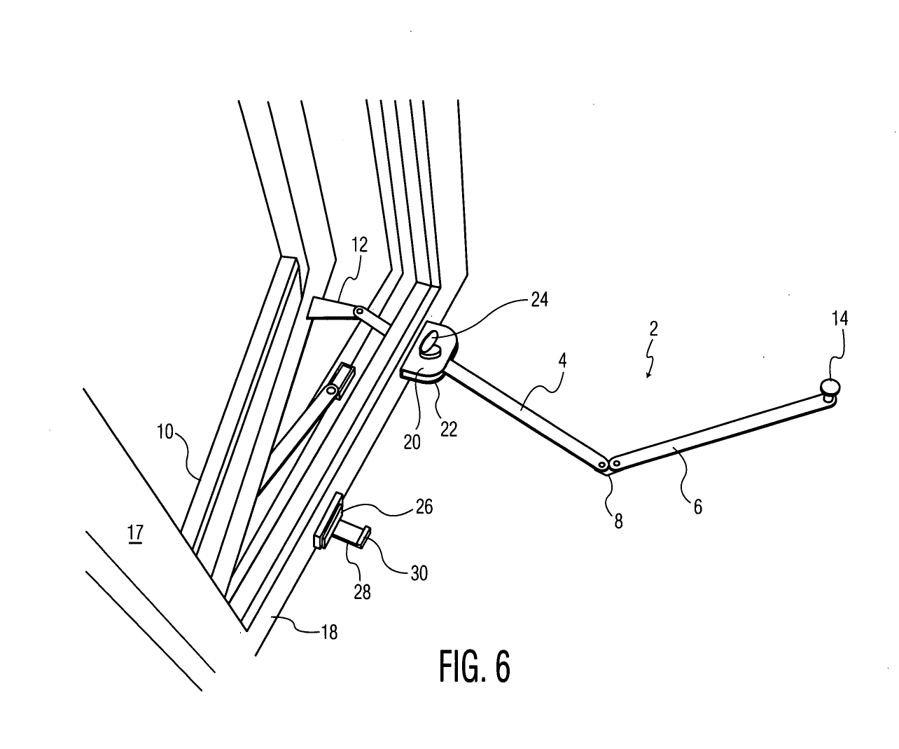

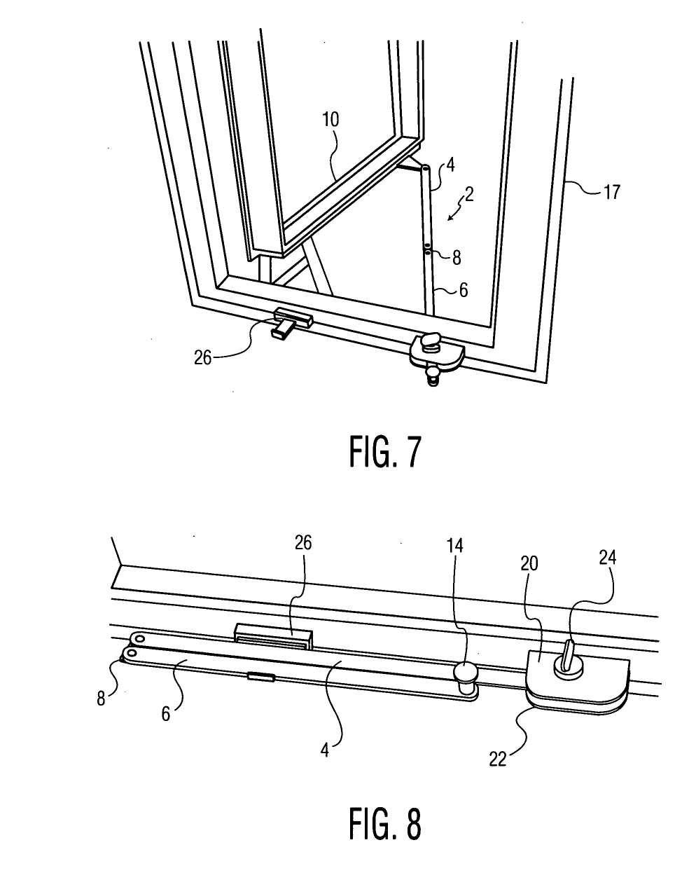

With reference to FIGS. 1 through 8 of the drawings, it will be seen that a casement window, formed in accordance with the present invention, includes a folding push bar 2, also formed in accordance with the present invention, comprising a first linkage 4 and a second linkage 6 joined together (through a short bridging linkage 8) at two ends thereof so that the first and second linkages may articulate with respect to one another. The first linkage 4 of the folding push bar 2 is pivotally attached to the window sash 10 of the casement window, and in particular, to a mounting member or plate 12 affixed to the window sash, at one end of the first linkage. The free end of the second linkage includes a projection 14 extending from a surface thereof.

One or several openings or slots 16 are formed through the thickness of the window frame 17 through which passes the first and second linkages of the folding push bar. Multiple openings arranged in a line in, for example, the sill 18 (i.e., the lower horizontal frame member) of the window frame, allow the push bar to be selectively positioned through one of the openings to allow the sash to pivot to its greatest (or a lesser) extent outwardly from the window frame on which it is mounted.

The projection situated at the free end of the second linkage prevents the folding push bar of the present invention from being inadvertently passed entirely through the opening or openings formed through the thickness of the window frame. On the top and bottom sides of one or more of the openings through the window frame are a pair of parallel plates 20, 22 projecting outwardly from the exposed interior surface of the window frame, between which the folding push bar extends. A thumb screw 24 or other device is threadingly received by an opening formed through the upper plate 20 (or alternatively the lower plate 22) and is positioned thereon in alignment with the folding push bar so that a user may tighten the thumb screw, which exerts pressure on the first or second linkage of the folding push bar between the upper plate 20 and lower plate 22, so that the window sash may be maintained at a desired angle of opening with respect to the window frame. The plates 20, 22 and thumb screw 24 together define a push bar immobilizer, and the thumb screw 24 defines a push bar movement inhibitor. A boot (not shown), preferably a bellows-type with a small opening formed therein, made from rubber, plastic or some other material, may be situated on the plates 20, 22 to surround and cover the plates and the slot 16 formed through the frame to minimize any air leakage through the slot 16.

In the folded position, the push bar will have its first and second linkages situated side-by-side and resting on a support formed as an L-shaped bracket 26 mounted to and extending from the sill of the window frame, out of the way of window treatments, furniture and the like positioned near the window. More specifically, the L-shaped bracket 26 includes a first leg 28 which is horizontally disposed and is provided to support the push bar 2 when the push bar is in a folded state, and a short vertical second leg 30 extending perpendicularly from the free end of the first leg 28 to prevent pivotal movement of the push bar 2 with respect to the window frame 17 and to maintain the push bar 2 in its folded state, unless the operator of the window lifts the folded push bar 2 off the L-shaped bracket 26 and over the short second leg 30 to extend the push bar.

One advantage of the casement window and the folding push bar of the present invention is that they allow up to a 90 degree range of operation (i.e., the window sash may be pivoted outwardly from the window frame on which it is mounted by up to about 90 degrees, which is a much greater range of operation than conventional casement windows with non-articulating push bars). Also, because the window sash may be pivoted up to 90 degrees with respect to the frame, it is easier to obtain access to both sides of the window so that they may be cleaned.

The locking push bar immobilizer feature, that is, the thumb screw 24 and parallel upper and lower plates 20, 22 provides for variable venting. Furthermore, the casement window hinges may be limited in a vent position with use of conventional tamper proof fasteners, in order to comply with New York City and other municipality child guard requirements. The window may further be conveniently locked in a particular position, either opened, or closed, and the push bar may be folded upon itself in a closed position in an unobstructive manner.

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

What is claimed is:

1. A folding push bar mechanism for use with a casement window, the casement window having a frame and a sash hingedly mounted on the frame and moveable with respect thereto, the folding push bar mechanism comprising:
a folding push bar, the folding push bar having a first linkage and a second linkage, the second linkage being operatively coupled to the first linkage to pivot with respect thereto; and
a push bar immobilizer, the push bar immobilizer being mounted on the window frame, the push bar immobilizer selectively engaging the push bar to prevent movement of the window sash with respect to the window frame.

2. A folding push bar mechanism for use with a casement window as defined by claim 1, wherein the folding push bar further comprises:
a bridging linkage, the bridging linkage having a first end and a second end situated opposite the first end, the first linkage being attached to the first end of the bridging linkage, the second linkage being attached to the second end of the bridging linkage.

3. A folding push bar mechanism for use with a casement window as defined by claim 2, wherein the bridging linkage has a length which is less than the length of each of the first linkage and the second linkage.

4. A folding push bar mechanism for use with a casement window as defined by claim 1, which further comprises.
a mounting member, the mounting member being attached to the window sash, the first linkage being pivotally attached to the mounting member.

5. A folding push bar mechanism for use with a casement window as defined by claim 1, wherein the second linkage of the folding push bar includes a free end; and wherein the folding push bar further comprises:
a projection, the projection being mounted on the free end of the second linkage.

6. A folding push bar mechanism for use with a casement window as defined by claim 1, wherein the push bar immobilizer includes:
a pair of spaced apart parallel plates, the push bar being received between the parallel plates; and
a push bar movement inhibitor, the push bar movement inhibitor selectively engaging the push bar.

7. A folding push bar mechanism for use with a casement window as defined by claim 6, wherein the push bar movement inhibitor includes:
a thumb screw, the thumb screw being threadingly received by at least one of the upper parallel plate and the lower parallel plate, the thumb screw selectively engaging the push bar to prevent movement of the window sash with respect to the window frame.

8. A folding push bar mechanism for use with a casement window as defined by claim 1, which further comprises:
a push bar support, the push bar support being mounted on the window frame, the push bar support supporting the folding push bar when the push bar is in a folded state.

9. A folding push bar mechanism for use with a casement window as defined by claim 8, wherein the push bar support is L-shaped and includes a first leg and a second leg extending perpendicularly from the first leg, the first leg selectively supporting the push bar when the push bar is in the folded state, the second leg being selectively engagable with the push bar to prevent pivotal movement of the push bar with respect to the window frame when the push bar is in the folded state.

10. A folding push bar mechanism for use with a casement window, the casement window having a frame and a sash hingedly mounted on the frame and moveable with respect thereto, the folding push bar mechanism comprising:
a folding push bar, the folding push bar having a first linkage and a second linkage operatively coupled to the first linkage to pivot with respect thereto, the second linkage having a free end;
a push bar immobilizer, the push bar immobilizer being mounted on the window frame, the push bar immobilizer selectively engaging the push bar to prevent movement of the window sash with respect to the window frame, the push bar immobilizer including a pair of spaced apart, parallel, upper and lower plates, the push bar being received between the parallel plates, and a push bar movement inhibitor, the push bar movement inhibitor selectively engaging the push bar, the push bar movement inhibitor including a thumb screw, the thumb screw being threadingly received by at least one of the upper parallel plate and the lower parallel plate, the thumb screw selectively engaging the push bar to prevent movement of the window sash with respect to the window frame;
a mounting member, the mounting member being attached to the window frame, the first linkage being pivotally attached to the mounting member;
a projection, the projection being mounted on the free end of the second linkage of the folding push bar; and
a push bar support supporting the folding push bar when the push bar is in a folded state, the push bar support being L-shaped and including a first leg and a second leg extending perpendicularly from the first leg, the first leg selectively supporting the push bar when the push bar is in the folded state, the second leg being selectively engagable with the push bar to prevent pivotal movement of the push bar with respect to the window frame when the push bar is in the folded state.

11. In combination:
a casement window, the casement window having a frame and a movable sash hingedly mounted on the frame, the frame having an opening formed through the thickness thereof;
a folding push bar mechanism, the folding push bar mechanism including a folding push bar having a first linkage and a second linkage, the first linkage being operatively pivotally coupled to the window sash, the second linkage being operatively coupled to the first linkage to pivot with respect thereto, the folding push bar passing through the opening formed in the window frame; and
a push bar immobilizer, the push bar immobilizer being mounted on the window frame in proximity to the opening, the push bar immobilizer selectively engaging the push bar to prevent movement of the window sash with respect to the window frame.

12. In combination:
a casement window, the casement window having a frame and a sash hingedly mounted on the frame and moveable with respect thereto;
a folding push bar, the folding push bar including a first linkage and a second linkage operatively coupled to the first linkage to pivot with respect thereto, the second linkage having a free end;
a push bar immobilizer, the push bar immobilizer being mounted on the window frame, the push bar immobilizer selectively engaging the push bar to prevent movement of the window sash with respect to the window frame, the push bar immobilizer including a pair of spaced apart, parallel, upper and lower plates, the push bar being received between the parallel plates, and a push bar movement inhibitor, the push bar movement inhibitor selectively engaging the push bar, the push bar movement inhibitor including a thumb screw, the thumb screw being threadingly received by at least one of the upper parallel plate and the lower parallel plate, the thumb screw selectively engaging the push bar to prevent movement of the window sash with respect to the window frame;
a mounting member, the mounting member being attached to the window frame, the first linkage being pivotally attached to the mounting member;
a projection, the projection being mounted on the free end of the second linkage of the folding push bar; and
a push bar support supporting the folding push bar when the push bar is in a folded state, the push bar support being L-shaped and including a first leg and a second leg extending perpendicularly from the first leg, the first leg selectively supporting the push bar when the push bar is in the folded state, the second leg being selectively engagable with the push bar to prevent pivotal movement of the push bar with respect to the window frame when the push bar is in the folded state.
